(19) United States
(12) Patent Application Publication
(10) Pub. No.: US 2013/0090814 A1
(43) Pub. Date: Apr. 11, 2013

(54) METHOD AND DEVICE FOR THE DETERMINATION OF AT LEAST ONE TRIGGERING PARAMETER OF PERSONAL PROTECTION MEANS OF A VEHICLE

(71) Applicants: Steffen Berndt, Eberdingen-Hochdorf (DE); Axel Settele, Eberdingen-Hochdorf (DE); Werner Nitschke, Asperg (DE); Josef Kolatschek, Weil Der Stadt (DE); Gunther Lang, Stuttgart (DE); Marcus Lehmann, Eberdingen (DE); Jasmin Szymanski, Stuttgart (DE); Bastian Reckziegel, Kirchheim/Nabern (DE); Marcel Maur, Asperg (DE)

(72) Inventors: Steffen Berndt, Eberdingen-Hochdorf (DE); Axel Settele, Eberdingen-Hochdorf (DE); Werner Nitschke, Asperg (DE); Josef Kolatschek, Weil Der Stadt (DE); Gunther Lang, Stuttgart (DE); Marcus Lehmann, Eberdingen (DE); Jasmin Szymanski, Stuttgart (DE); Bastian Reckziegel, Kirchheim/Nabern (DE); Marcel Maur, Asperg (DE)

(21) Appl. No.: 13/637,486

(22) PCT Filed: Mar. 1, 2011
(86) PCT No.: PCT/EP2011/052973

§ 371 Date: Dec. 10, 2012

(30) Foreign Application Priority Data
Mar. 26, 2010 (DE) 1020100033332

(51) Int. Cl. B60R 21/0132

(52) U.S. Cl. CPC B60R 21/0132
USPC 701/46

(57) ABSTRACT

A method to determine at least one triggering parameter of personal protection device of a vehicle using pattern signal curves of a possible signal of a sensor for a physical variable. The pattern signal curves replicating a curve over time of the physical variable upon impact of an object on the vehicle at a different location on the vehicle and/or upon impact of the object on the vehicle at a different angle. A sensor signal is read which represents the physical variable measured by a sensor. Values of a curve over time of the sensor signal are compared to values of the at least two pattern signal curves, that pattern signal curve being selected which, in at least one time segment of the pattern signal curve or one scaled form of the pattern signal curve has a lower deviation from the curve over time of the sensor signal.

### FIELD OF THE INVENTION

The present invention relates to a method and a device for determining at least one triggering parameter of a vehicle's personal protection devices.

### BACKGROUND INFORMATION

In the case of air bag systems, conventionally, a very complex algorithm is used for controlling the triggering of the air bags. The sensor data have to be evaluated, and in conclusion it has to be decided whether the ignition of the means of restraint (such as air bags) is to take place or not, and whether additional outputs, such as a hazard warning system will be activated. This differentiation requires the cooperation of a multitude of functions, which are formed from the crash signals by mathematical functions such as interaction, comparison, etc. Because of the connecting together of many complex functions, the algorithm does not appear clear, and is difficult to explain physically.

### SUMMARY

In accordance with the present invention, an example method, an example device using this method, and finally a corresponding computer program product are provided. Advantageous refinements are yielded from the description below.

In accordance with the present invention, an example method is provided for determining at least one triggering parameter of a vehicle's personal protection devices, the method including the following steps:
providing at least two pattern signal characteristics of a possible signal of a sensor for a physical variable, each of the pattern signal curves representing a curve over time of the physical variable upon impact of an object on the vehicle at a different location on the vehicle and/or upon impact of the object on the vehicle at a different angle; at least one triggering parameter being assigned to each of the pattern signal curves for an algorithm for triggering the personal protection devices.
reading in a sensor signal which represents the physical variable measured by a sensor;
comparing values of a curve over time of the sensor signal to values of the at least two pattern signal curves, in the step of comparing, that pattern signal curve being selected which, in at least one time segment of the pattern signal curve or one scaled form of the pattern signal curve has a lower deviation from the curve over time of the sensor signal; and
ascertaining the at least one triggering parameter of the selected pattern signal curve for the algorithm for triggering the personal protection devices.

In accordance with the present invention, an example device is provided for determining at least one triggering parameter of a vehicle's personal protection devices, the example device including the following features:
a unit for providing at least two pattern signal curves of a possible signal of a sensor for a physical variable, each of the pattern signal curves representing a curve over time of the physical variable upon impact of an object on the vehicle at a different location on the vehicle and/or upon impact of the object on the vehicle at a different angle; at least one triggering parameter being assigned to each of the pattern signal curves for an algorithm for triggering the personal protection device;
a unit for reading in a sensor signal which represents the physical variable measured by a sensor;
a unit for comparing values of a curve over time of the sensor signal to values of the at least two pattern signal curves, the unit for comparing being developed to select that pattern signal curve which, in at least one time segment of the pattern signal curve or one scaled form of the pattern signal curve, has a lower deviation from the curve over time of the sensor signal; and
a unit for ascertaining the at least one triggering parameter of the selected pattern signal curve for the algorithm for triggering the personal protection device.

In accordance with the present invention, an example control unit is also provided that is developed to carry out or implement the steps of the example method according to the present invention. The control unit may particularly have devices that are developed for each to carry out one step of the method. The object of the present invention may also be achieved quickly and efficiently by this embodiment variant of the present invention in the form of a control unit.

In the case at hand, a control unit or device may be understood to be an electrical unit which processes sensor signals and outputs control signals as a function thereof. The control unit may have an interface, which may be developed as hardware and/or software. In a hardware design, the interfaces may, for example, be part of a so-called system ASIC, which contains the most varied functions of the control unit. However, it is also possible for the interfaces to be separate, integrated switching circuits or to be at least partially made up of discrete components. In a software design, the interfaces may be software modules which are present on a microcontroller in addition to other software modules, for example.

Also of advantage is a computer program product having program code for carrying out the example method according to one of the specific embodiments described above, which is used when the program is run on a control unit. The program code, in this instance, may be stored on a machine-readable carrier, such as a semiconductor memory, a hard-disk memory or an optical memory.

In accordance with the present invention, particularly in time-critical evaluation situations, a triggering parameter is able to take place very rapidly based on a simple comparison of a measured curve of the sensor signal to a previously determined pattern signal curve. This pattern signal curve may be, for instance, a signal curve of a sensor signal over an acceleration, a pressure, a force and/or a path, this sensor signal, in the case of an impact of an object on the vehicle being recorded under laboratory conditions or calculated from the known vehicle body stiffness. The pattern signal curve then represents an impact of an object on the vehicle, at a certain speed, at a certain location on the vehicle and/or at a certain angle onto the vehicle. Each of the pattern signal curves, in this context, represents a different accident scenario, which is distinguished by a certain impact angle, a certain type of object or a certain angle of strike of the object on the vehicle. The triggering parameter associated with the respective pattern signal curve may be a triggering time for triggering the personal protection device or the strength of the triggering of this personal protection device. The triggering parameter may also be determined in such a way that, after the detection of an accident scenario, (or a kind of impact) a certain delay time is awaited before the personal protection devices are triggered or activated.

The advantage of using the pattern signal curves described above that these pattern signal curves already portray data on the auto body stability, so that, for example, in a frontal impact of the object onto the vehicle, one may first expect a certain signal curve because of the impression of the bumper and subsequently a certain signal curve because of the impression of the frame longitudinal member. In the real accident scenario this pattern signal curve may then be drawn upon and compared to the actual signal curve. That pattern signal curve, which demonstrates the greatest agreement in at least one (first) time segment with the actually measured signal curve, will then also correspond with the greatest probability to the accident scenario that has actually occurred. This means that an impact of the object at a certain speed, at a certain location on the vehicle and/or at a certain angle onto the vehicle may be assumed on which the pattern signal curve, that is selected, is based. For this accident scenario a corresponding triggering parameter may then be determined for triggering the personal protection devices, which is associated with this accident scenario, or rather the selected pattern signal curve, and which enables the optimal protective strategy for a passenger. Furthermore, the accident scenario detected may also very well have its plausibility checked if the actual curve over time of the detected sensor signal continues to be calibrated against the selected pattern signal curve and a deviation between the signal curve over time and the selected pattern signal curve remains a minimum with regard to further pattern signal curves.

The present invention may offer the advantage that a very rapid and computationally non-powerful determination is possible, of an accident scenario that has occurred. For this purpose, one may resort to predetermined pattern signal curves which are, for instance, picked up under laboratory conditions or are ascertained from a knowledge of the vehicle body stiffness and which represent the predefined accident types.

It is favorable if, in the step of providing, a speed of the impact of the object on the vehicle is assigned to each of the two provided pattern signal curves, and in the step of comparing, a current speed of the vehicle is estimated while using the speed assigned to the pattern signal curve and a ratio of a value of the pattern signal curve and a corresponding value of the curve over time of the sensor signal. Such a specific embodiment of the present invention offers the advantage that, for instance, for an impact angle of the object on the vehicle, only a single pattern signal curve has to be provided, in the case of which the speed of the object impact is also known. Now, if the object hits the vehicle at this impact angle, however, at a different speed from the one on which the pattern signal curve is based, then, because of the ratio formation mentioned, the respective pattern signal curve may continue to be used for a multitude of impact speeds. Consequently, only a small number of pattern signal curves has to be picked up or calculated and evaluated for the evaluation of the current accident scenario, which represents a clear unloading for a corresponding evaluation unit.

Also, in the step of comparing, the speed of the vehicle may be estimated from a height and/or a width of the first maximum of the curve over time of the sensor signal compared to the maximum of the pattern signal curve. Such a specific embodiment of the present invention offers the advantage that, because of this technically very simple evaluation of a width and/or a height of the first maximum, body stiffness data, which are contained in the pattern signal curve, may be determined optimally for the rapid determination of the speed of the vehicle with respect to the impacting object.

It is an advantage if, in the step of ascertaining, a triggering time and/or a delay time for a triggering of the personal protection devices are ascertained as the triggering parameter. Such a specific embodiment of the present invention offers the advantage that one is already able to detect ahead of time a specific accident scenario by the evaluation of the pattern signal curve, before the optimal activation time for the personal protection devices has occurred. Because of this, the use of the present invention is possibly able to replace prospective sensors, which would distinguish itself economically by a corresponding cost reduction.

In order to make possible as simple as possible a comparison between the curve over time of the sensor signal to one of the pattern signal curves, in the step of providing, pattern signal curves may be provided in which a pattern signal curve has, at least by segment, polynomials of the first order, especially in which the pattern signal curves are composed of straight line segments.

According to the specific embodiment of the present invention, in the step of comparison, information with respect to at least one gradient, one width, one maximum value, one minimum value, one inflection point and/or one amplitude height of the curve over time may be compared to one of the pattern signal curves or a scaled form of the pattern signal curve, in order to calculate a deviation of the signal curve over time from the pattern signal curve or the scaled form of the pattern signal curve. Such a specific embodiment of the present invention offers the advantage that, by using one or more of the distinguishing points named of the sensor signal curve over time or of one of the pattern signal curves, a more precise evaluation possibility of the actual accident event is possible by mathematically mature methods.

In order to mask out a sensor signal interference to the greatest extent possible, and to enable as robust an evaluation as possible of the curve over time of the sensor signal, in the step of reading in, sensor signals may be read in and used for the formation of a curve over time of the sensor signal which are obtained after a window integral formation over the measured physical variable.

Furthermore, after the step of ascertaining, the ascertained triggering parameter is able to be verified by carrying out an additional step of comparing a curve over time of the sensor signal to the at least two pattern signal curves, in the additional step of comparing a triggering parameter being verified if the selected pattern signal curve, in at least one additional time segment of the pattern signal curve, or one scaled form of the pattern signal curve, has a smaller deviation from the curve over time of the sensor signal than at least one other pattern signal curve. Such a specific embodiment of the present invention offers the advantage of continuous checking as to whether the selected pattern signal curve, and thus the detected accident scenario, still represent the best selection for the present accident situation. It may possibly also be detected that the originally made prediction of the accident scenario based on the corresponding pattern signal curve is no longer conclusive, so that another triggering strategy and/or another triggering parameter should be selected for the personal protection devices.

The present invention is explained in greater detail by way of example, with reference to the figures.

### BRIEF DESCRIPTION OF THE DRAWINGS

FIG. 1 shows a block diagram having components that are able to be used for the execution of a first exemplary embodiment of the present invention.

FIG. 2 shows a schematic representation of a pattern signal curve.

FIGS. 3a-c show representations of diagrams of pattern signal curves with respect to curves over time of a signal from a sensor that was actually measured and averaged by a window integral.

FIG. 4 shows a flow chart of an exemplary embodiment of the present invention as a method.

### DETAILED DESCRIPTION OF EXAMPLE EMBODIMENTS

In the figures, same or similar elements may be shown by same or similar reference numerals, a repeated description of these elements being omitted. Furthermore, the figures and their description contain numerous features in combination. In this context, it is clear to one skilled in the art that these features may also be considered individually or may be combined to form further combinations not explicitly described here. Furthermore, the present invention will be explained in the following description using different measures and dimensions, while the present invention should be understood as not being restricted to these measures and dimensions. Furthermore, example method steps according to the present invention may also be carried out repeatedly, as well as in a different sequence than the one described. If the exemplary embodiment includes an “and/or” linkage between a first feature/step and a second feature/step, this may be read to mean that the exemplary embodiment, according to one specific embodiment has both the first feature/the first step and also the second feature/the second step, and according to an additional specific embodiment, either has only the first feature/step or only the second feature/step.

FIG. 1 shows a block diagram of the arrangement of components using which the approach according to the present invention is able to be carried out according to a first exemplary embodiment. A vehicle 100 is shown in FIG. 1, in this context, which has a sensor 120, such as an acceleration sensor in the front area 110. Sensor 120, however, may also measure another physical variable, such as a pressure, a deformation path in the deformation of an auto body element or a similar physical variable. Moreover, sensor 120 is connected to an evaluation unit 130 (which may, for instance, be the central air bag control unit) which, in turn, is connected to a memory 140, in which a plurality of pattern signal curves are stored. Of these pattern signal curves, for example, under laboratory conditions, in response to an impact of an object having a different size, different speed and/or different angles at different locations onto the vehicle, the measurement was determined, or based on the known body structure of vehicle 100 was computationally determined or recorded under laboratory conditions.

Now, if, during travel of vehicle 100, an impact of object 150 (such as a tree or an oncoming vehicle) onto one's own vehicle 100 is detected, this leads to a characteristic curve over time of the signal of sensor 120, that is caused by the deformation of the individual body elements of vehicle 100. For example, bumper 152 in front area 110 of vehicle 100 is first deformed, and absorbs a part of the impact energy. If the impact energy is not completely absorbed by the deformation of bumper 152, an additional absorption of impact energy takes place by the deformation of an impact damping element 154, which is installed between bumper 152 and a frame longitudinal member 156 of vehicle 100. If the impact energy is not able to be completely absorbed even by the deformation of impact damping element 154, additional energy is able to be absorbed by a deformation of frame longitudinal member 156, as will be explained in greater detail below. Therefore, because of the deformation of the corresponding auto body elements, during the impact, a certain curve over time of the (negative) acceleration of vehicle 100 is detected by sensor 120 (if the sensor represents a sensor for recording acceleration), which is compared in evaluation unit 130 to a plurality of pattern signal curves, which are loaded for this purpose from memory 140 into evaluation unit 130. In evaluation unit 130, that pattern signal curve is able to be selected which agrees best with the curve over time of the signal of sensor 120, that is, which, for example, has the least point-wise deviation from the curve over time of the signal of sensor 120. After it is known for each pattern signal curve which accident scenario it portrays (i.e., which type of object 150 is impacting at what speed and which angle at which location on vehicle 100), a triggering parameter is able to be selected for triggering a personal protection means 160 (such as an air bag or a belt tensioner). In this context, the triggering parameter for triggering the personal protection device is usually associated with the pattern signal curve, since, because of the accident research data that are voluminously present, it is known which personal protection device is to be activated in which accident scenario at what time, in order to protect a vehicle passenger 170 as well as possible.

An exemplary embodiment of the procedure according to the present invention is described in greater detail below. The approach introduced in the present description, which will also be designated below as a “basic line algorithm”, as already noted, uses the curve of the energy reduction that is dependent on the vehicle (body) structure. The energy reduction is represented by the speed reduction over time (i.e., an acceleration) in the crash. The speed curve (that is, for example, the curve shape of a pattern signal curve that was picked up under laboratory conditions or was computed theoretically) carries within it important data of the crash (accident). By comparing the real speed curve to the theoretical curve (that is, the pattern signal curve) for a vehicle type, the crash type is able to be ascertained and the necessary means of restraint (e.g., air bag) and outputs (e.g., warning blinkers, . . . ) may be activated. The vehicle structure, described by few parameters, is directly included in the “basic line algorithm”.

In the case of the “basic line algorithm”, the signature of the vehicle structure is detected directly because of the curve over time of, for instance, of the acceleration signals or the speed signals, and, with the aid of this knowledge, the correct or optimal restraint device (e.g., air bag) are activated in full force and triggering time, as well as appropriate outputs (e.g., warning blinkers, . . . ). The vehicle-specific structural blocks, such as the front cross member, a deformation element (e.g., a crashbox or an impact damping element) and a frame longitudinal member muster different resistance forces/deformation forces when an object impacts on the vehicle. The counterforces, which occur in response to the impact of an object on this vehicle element or body element, at a known mass (i.e., the vehicle mass) determine the acceleration signal that is to be expected. This acceleration signal is replicated (either computed theoretically or picked up under laboratory conditions) and is stored as a pattern signal curve. In this context, for the simple evaluation capability, simple pattern signal curves should be selected which are able to be described, for instance, as simply as possible (but sufficiently) by segment, using a polynomial of the first order.

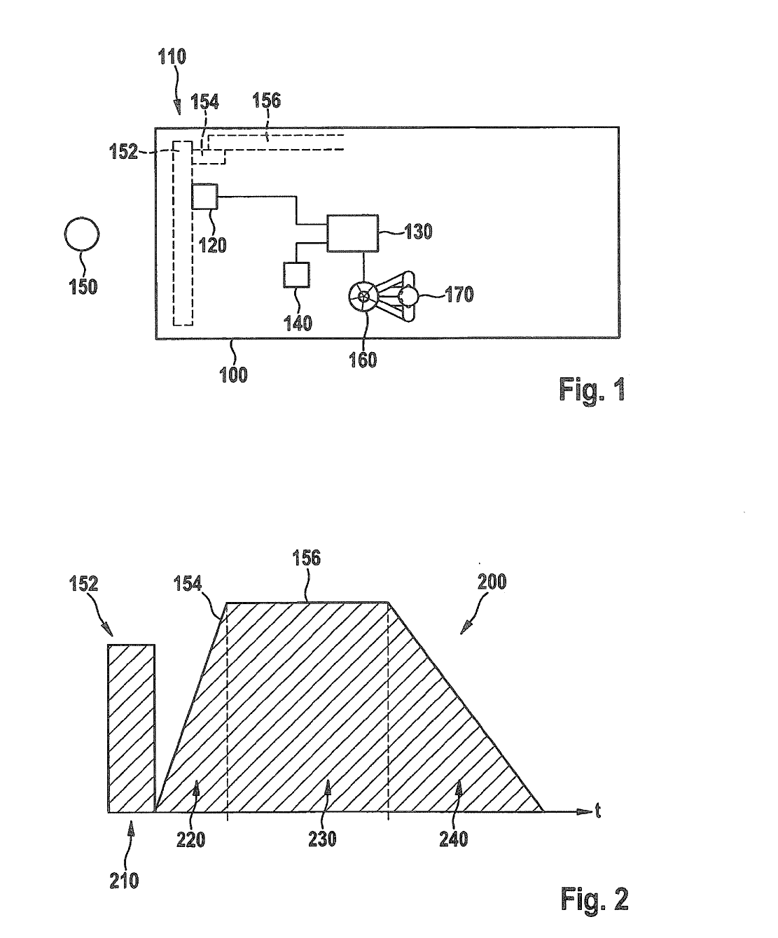

In FIG. 2 a diagram is shown using polynomials of the first order, of an example of a pattern signal curve 200 for a theoretical acceleration signal. In this instance, pattern signal curve 200 has a rectangular shape 210. This corresponds to a simplified curve of an acceleration signal when an object deforms bumper 152 of vehicle 100 upon impact on vehicle 100. Subsequently, pattern signal curve 200 has a ramp shape 220, which corresponds to a curve of the acceleration signal in vehicle 100, when a deformation or impact damping element 154 is deformed, which is installed between bumper 152 and frame longitudinal member 156 of vehicle 100. Following this, pattern signal curve 200 again has a rectangular form 230, which represents a curve over time of the acceleration signal in vehicle 100, when a deformation takes place of frame longitudinal member 156. Because of reflections of impact pulses, shock waves may appear in the vehicle structure which are represented in pattern signal curve 200 by a declining ramp shape 240, which follows rectangular shape 230 in time. This area is also designated as “rebounce” in vehicle 100.

For objects 150 of different size and different rapidity, as well as for different angles of impact and/or places of impact of object 150 on vehicle 100, different pattern signal curves 200 may be stored in each case in memory 140, which are then drawn upon for comparison to the curve over time of the signal of sensor 120. For reasons of signal processing time, not too many pattern signal curves should have to be processed in this context, the relative speeds between impact object 150 and vehicle 100 being also able to be estimated by forming a ratio between the amplitudes of the pattern signal curve and the amplitudes of the curve over time of the sensor signal. For this reason, one does not necessarily have to store individual pattern signal curves for accident scenarios, which differ except for the relative speed between impact object and vehicle.

In this way, using few parameters which describe these structural elements of the vehicle in its geometrical extent, by simple comparison of the real signal curve to the theoretical curve from the pattern signal curve, the crash type and the relative speed difference between obstacle and vehicle are able to be ascertained, and the required restraint device (e.g., air bag) and outputs (e.g., warning blinkers, . . . ) are able to be activated.

Such a comparison may be carried out based on the pattern signal curve, the pattern signal curve representing a speed, an acceleration, an average acceleration (e.g., averaged over 10 ms), a force curve, a pressure curve, a path curve or a further physical variable, which changes during the course of the crash.

By this comparison, the following crash types are able to be distinguished very simply when the corresponding pattern signal curves are provided:
flat frontal
angular crash
pole crash
AZT (AZT=Allian[z] Zentrum [für] Technik [Allianz Center [for] Technology], in which a crash has been specified for insurance estimation)
ODB (ODB=offset crash with a deformable barrier)
vehicle to vehicle crash and
other accidents.

Some advantages of using the “basic line algorithm” may be summarized as follows:
The evaluation is simpler, i.e., during processing, a few parameters are sufficient (the respective parameters may also be measured directly on the automobile).
For this reason, the approach presented is also less prone to error, and
more cost-effective.
Besides that, a more rapid detection of an accident scenario is also possible using the pattern signal curves provided, which is particularly relevant in a real-time system having limited computing resources, since often times only a short time span of 500 μs, for example, is available to a real-time cycle for software and algorithms.

The acceleration signals (i.e. the signals of sensor 120, for instance) are analyzed in real-time mode during the crash. For the analysis, the values from the window integral of the acceleration signals are used, (for instance, for this purpose, a window integral having a running time of 8 ms is formed in evaluation unit 130, the value for the vehicle type being set during the application). When a noise threshold is exceeded, the “basic line algorithm” begins with the computation. The data on gradient, width, maximum and minimum value, inflection points and/or amplitude height are compared in time with the theoretical curves of pattern signal curve 200. The height of the first maximum in comparison to the height of the first maximum of the pattern signal curve is correlated to a theoretically calculated speed for each crash type. When the signal curve drops off again, one is able to determine the crash type that has occurred (i.e. the accident scenario that has occurred during the travel) via the width of the first maximum in the curve over time as compared to the width of the first maximum of the pattern signal curve. That being the case, information on a possible crash type is available at an early time, which is verified in the further curve over time of the signal (compared to the curve of the pattern signal curve).

The comparison inclusive of the verification takes place in the following manner, for example: For each measured value as of the exceeding of the noise threshold, at least one comparison is carried out per crash type (that is, per pattern signal curve). The deviations between the theoretical signal curve of the pattern signal curve and the real signal curve (that is, the curve of the signal from the sensor) are cleared per crash type (i.e., with the corresponding individual pattern signal curves), summed in absolute amount, for example, and a probability is determined per crash type, as to whether this crash type has actually occurred. The crash type whose associated pattern signal curve demonstrates the lowest deviation from the curve over time of the sensor signal receives the highest probability and is consequently selected. A speed may be estimated for each crash type (as, for instance, described above from the height and width of the first maximum) which speed permits one to draw a conclusion on an unequivocal triggering time as the triggering parameter.

The triggering time associated with the most probable crash type is selected, for example, as the triggering parameter for triggering the necessary personal protection device or restraint device (such as an air bag or belt tensioner) and/or the outputs (such as warning blinkers, . . . ) and passed on to the corresponding ignition stage for these personal protection devices.

Up to the time of the desired triggering of the personal protection means, the remaining time is used to verify the type of crash.

However, if it turned out in the evaluation of the curve over time of the signal from the sensor that the first rising side of this curve over time already exceeds a first specified value, such as 25 g, then a so-called high-speed crash is involved, which leads to an immediate activation of a first personal protection device or the first restraint device threshold (e.g., belt tensioner), and upon the reaching of an additional higher threshold, such as 35 g, a second personal protection device or a restraint device threshold is activated (e.g., air bag first stage). Possible alternatives come about by the use of different sensors for providing the sensor signal to evaluation unit 130.

The basic line algorithm may be used for all types of crash signals. For instance, acceleration signals, pressure signals, travel signals, force signals . . . may be processed using always the same procedure in order to activate the correct restraint device (e.g., air bag) and outputs (e.g., warning blinkers, . . . ).

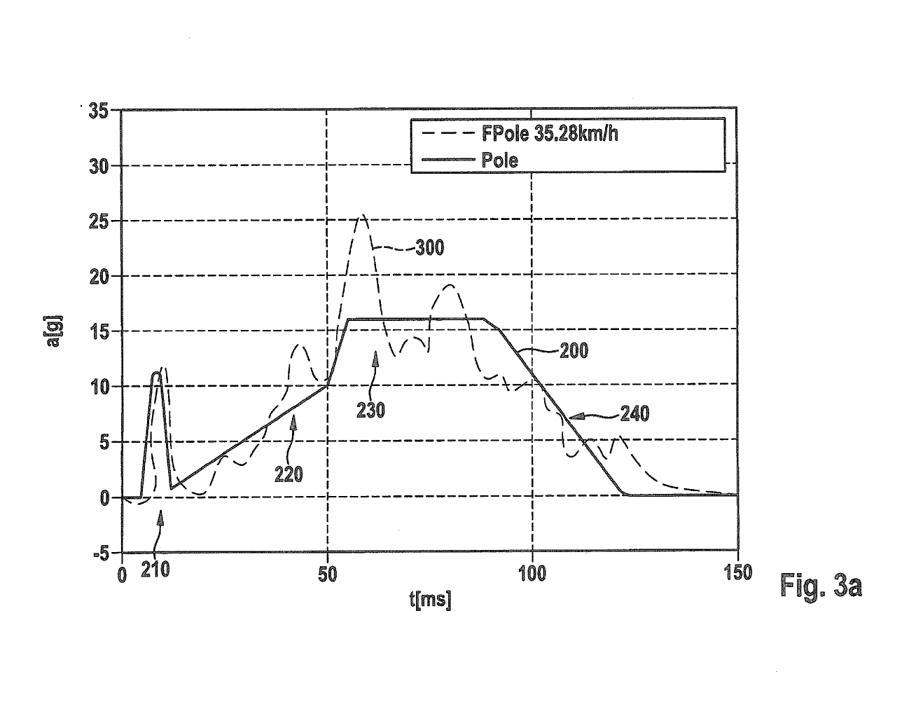

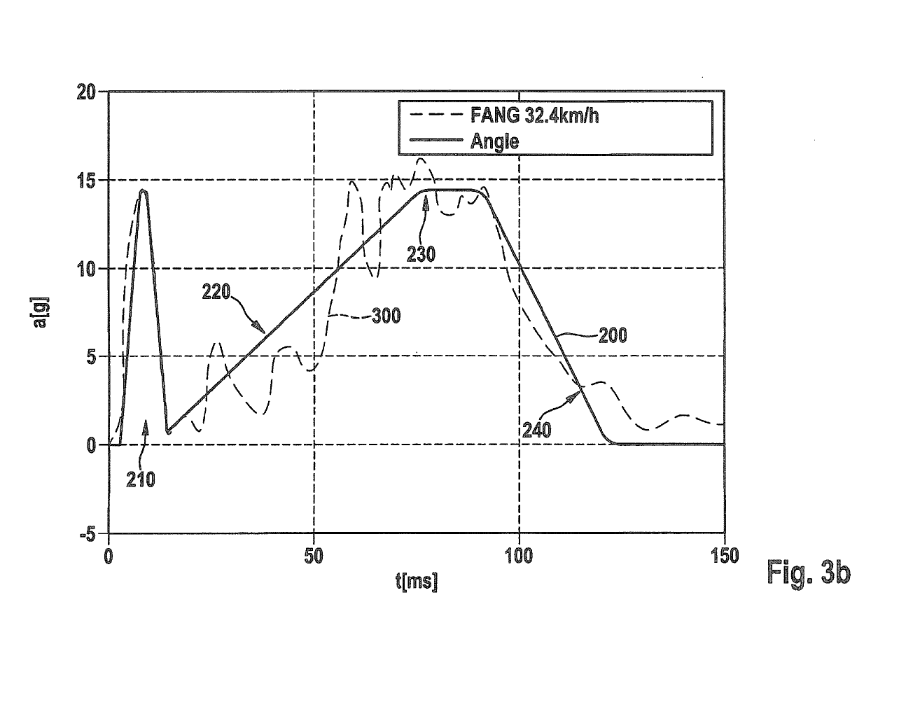

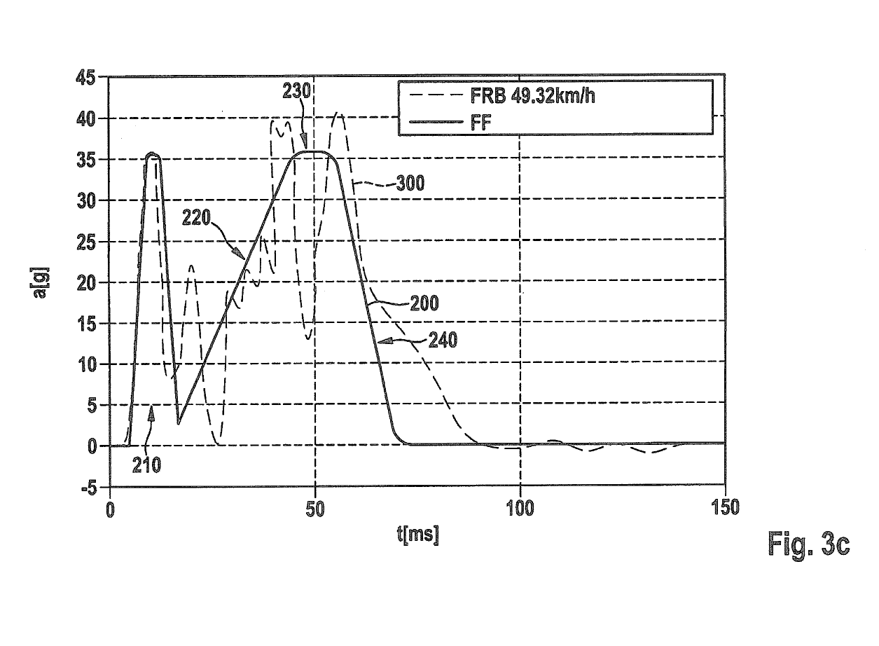

FIGS. 3a to 3c show representations of real and theoretical signal curves, curves over time 300 of the sensor signal being shown as a dashed line and pattern signal curves 200 as a solid line. Dashed line 300, in this context, reflects the curve over time of the average values of the acceleration signals over 5 ms (that is, when using a window integral of 5 ms length). In FIGS. 3a to 3c, time t is plotted in ms as shown on the abscissa, and on the ordinate the (window integral low-pass)-filtered acceleration a in units of g is plotted. In FIG. 3a, the signal curves over time of an impact of a pole on a VW Polo at a relative speed of 25.28 km/h is shown schematically. In FIG. 3b, the signal curves over time of an impact of a pole at an angle onto a VW Polo at a relative speed of 34.4 km/h is shown schematically, whereas in FIG. 3c, the signal curves of a frontal impact onto a VW Polo at a relative speed of 49.32 km/h is shown schematically.

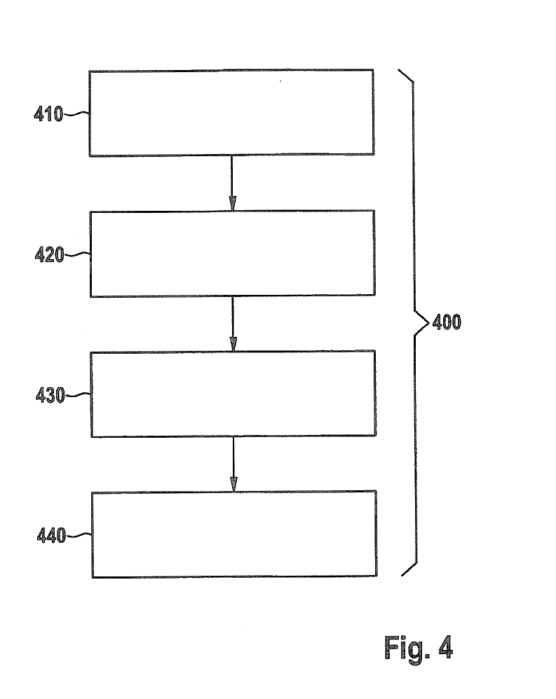

FIG. 4 shows a flow chart of an exemplary embodiment of the present invention as method 400, for determining at least one triggering parameter of a personal protection device of a vehicle. In this context, method 400 has a step of providing 410 at least two pattern signal curves of a possible signal of a sensor for a physical variable, each of the pattern signal curves representing a curve over time of the physical variable upon impact of an object on the vehicle at a different location on the vehicle and/or upon impact of the object on the vehicle at a different angle; at least one triggering parameter being assigned to each of the pattern signal curves for an algorithm for triggering the personal protection device. Furthermore, method 400 has a step for reading in 420 of a sensor signal which represents the physical variable measured by a sensor. Method 400 also includes a step of comparing 430 values of a curve over time of the sensor signal to values of the at least two pattern signal curves, in the step of comparing, that pattern signal curve being selected which, in at least one time segment of the pattern signal curve or one scaled form of the pattern signal curve has a lower deviation from the curve over time of the sensor signal. Finally, method 400 includes a step for ascertaining 440 the at least one triggering parameter of the selected pattern signal curve for the algorithm for triggering the personal protection device.

1-10. (canceled)

11. A method for the determination of at least one triggering parameter of a personal protection device of a vehicle, comprising:
providing at least two pattern signal curves of a possible signal of a sensor for a physical variable, each of the pattern signal curves replicating a curve over time of a physical variable upon at least one of impact of an object on the vehicle at a different location on the vehicle, and impact of the object on the vehicle at a different angle, at least one triggering parameter being assigned to each of the pattern signal curves for an algorithm for triggering the personal protection device;
reading in a sensor signal which represents the physical variable measured by a sensor;
comparing values of a curve of the sensor signal over time to values of the at least two pattern signal curves, and selecting a pattern signal curve of the at least two pattern signal curves which, in at least one time segment of the pattern signal curve or one scaled form of the pattern signal curve, has a lower deviation from the curve over time of the sensor signal; and
ascertaining the at least one triggering parameter of the selected pattern signal curve for the algorithm for triggering the personal protection device.

12. The method as recited in claim 11, wherein, in the providing step, a speed of the impact of the object on the vehicle is assigned to each of the two provided pattern signal curves, and in the comparing step, a current speed of the vehicle is estimated while using a speed assigned to the pattern signal curve and a ratio of a value of the pattern signal curve and a corresponding value of the curve over time of the sensor signal.

13. The method as recited in claim 12, wherein, in the comparing step, a speed of the vehicle is estimated from at least one of a height and a width of a first maximum of a curve of the sensor signal over time compared to a maximum of the pattern signal curve.

14. The method as recited in claim 11, wherein, in the ascertaining step, at least one of a triggering time and a delay time for a triggering of the personal protection device are ascertained as the triggering parameter.

15. The method as recited in claim 11, wherein, in the providing step, pattern signal curves are provided in which the pattern signal curves have polynomials of the first order at least by segment, in which the pattern signal curves are composed of straight line segments.

16. The method as recited in claim 11, wherein, in the comparing step, information with respect to at least one of a gradient, a width, a maximum value, a minimum value, an inflection point, and an amplitude height of the curve over time is compared to one of: i) the pattern signal curves, or ii) a scaled form of the pattern signal curve, to calculate a deviation of the curve of the sensor signal over time from the one of the pattern signal curve or the scaled form of the pattern signal curve.

17. The method as recited in claim 11, wherein, in the reading in step, sensor signals are read in and used for forming the curve of the sensor signal over time, which are obtained according to a window integral formation for the physical variable.

18. The method as recited in claim 11, wherein, after the ascertaining step, the ascertained triggering parameter is verified by carrying out an additional step of comparing a curve of the sensor signal over time to the at least two pattern signal curves, in the additional step of comparing, a triggering parameter being verified if the selected pattern signal curve, in at least one additional time segment of one of the pattern signal curve, or a scaled form of the pattern signal curve, has a smaller deviation from the curve of the sensor signal over time than at least one other pattern signal curve.

19. A device for determination of at least one triggering parameter of a personal protection device of a vehicle, comprising:
a unit configured to provide at least two pattern signal curves of a possible signal of a sensor for a physical variable, each of the pattern signal curves replicating a curve over time of the physical variable at least one of upon impact of an object on the vehicle at a different location on the vehicle, and upon impact of the object on the vehicle at a different angle, at least one triggering parameter being assigned to each of the pattern signal curves for an algorithm for triggering the personal protection device;
a unit configured to read in a sensor signal which represents the physical variable measured by a sensor;
a unit configured to compare values of a curve of the sensor signal over time to values of the at least two pattern signal curves, and to select one of the pattern signal curves which, in at least one time segment of one of the pattern signal curve or one scaled form of the pattern signal curve, has a lower deviation from the curve of the sensor signal over time; and
a unit configured to ascertain the at least one triggering parameter of the selected pattern signal curve for an algorithm for triggering the personal protection device.

20. A computer readable storage medium storing program code for the determination of at least one triggering parameter of a personal protection device of a vehicle, the code, when executed by a processor, causing the processor to perform the steps of:
providing at least two pattern signal curves of a possible signal of a sensor for a physical variable, each of the pattern signal curves replicating a curve over time of a physical variable upon at least one of impact of an object on the vehicle at a different location on the vehicle, and impact of the object on the vehicle at a different angle, at least one triggering parameter being assigned to each of the pattern signal curves for an algorithm for triggering the personal protection device;
reading in a sensor signal which represents the physical variable measured by a sensor;
comparing values of a curve of the sensor signal over time to values of the at least two pattern signal curves, and selecting a pattern signal curve of the at least two pattern signal curves which, in at least one time segment of the pattern signal curve or one scaled form of the pattern signal curve has a lower deviation from the curve over time of the sensor signal; and
ascertaining the at least one triggering parameter of the selected pattern signal curve for the algorithm for triggering the personal protection device.
